(19) United States
(12) Patent Application Publication
(10) Pub. No.: US 2008/0074562 A1
(43) Pub. Date: Mar. 27, 2008

(54) Display system comprising a mirror device with oscillation state

(76) Inventors: Taro Endo, Tokyo (JP); Yoshihiro Maeda, Tokyo (JP); Kazuma Arai, Tokyo (JP); Hirokazu Nishino, Tokyo (JP); Fusao Ishii, Menlo Park, CA (US)

Correspondence Address: Bo-In Lin, 13445 Mandoli Drive, Los Altos Hills, CA, 94022, US

(21) Appl. No.: 11/894,232

(22) Filed: Aug. 18, 2007

Related U.S. Application Data
(63) Continuation-in-part of application No. 11/121,543, filed on May 4, 2005, now Pat. No. 7,268,932.
Application No. 11/121,543 is a continuation-in-part of application No. 10/698,620, filed on Nov. 1, 2003.
Application No. 11/121,543 is a continuation-in-part of application No. 10/699,140, filed on Nov. 1, 2003, now Pat. No. 6,862,127.
Application No. 11/121,543 is a continuation-in-part of application No. 10/699,143, filed on Nov. 1, 2003, now Pat. No. 6,903,860.
(60) Provisional application No. 60/840,878, filed on Aug. 29, 2006.

(51) Int. Cl. H04N 5/74; G02F 1/00; H04N 9/31

(52) U.S. Cl. 348/758; 348/744; 348/E05.139

(57) ABSTRACT

The present invention provides a display system, comprising: a display device having a plurality of mirrors and an oscillating state; and a processor processing an input video signal and controlling the display device, wherein the processor generates a control signal for controlling the individual mirrors constituting an image based on a value of at least either of a reflection light intensity L, or of an oscillation period T, of a predetermined mirror.

This application is a Non-provisional Application of a Provisional Application 60/840,878 filed on Aug. 29, 2006. The Provisional Application 60/840,878 is a Continuation in Part (CIP) application of a pending U.S. patent application Ser. No. 11/121,543 filed on May 4, 2005. The application Ser. No. 11/121,543 is a Continuation in part (CIP) application of three previously filed Applications. These three applications are Ser. No. 10/698,620 filed on Nov. 1, 2003, Ser. No. 10/699,140 filed on Nov. 1, 2003, and Ser. No. 10/699,143 filed on Nov. 1, 2003 by one of the Applicants of this patent application. The disclosures made in these patent applications are hereby incorporated by reference in this patent application.

### BACKGROUND OF THE INVENTION

1. Field of the Invention

This invention relates to a projection display systems, and more particularly improves the level of gray scale of a projection display using a micromirror device.

2. Background Art

Even though there have been significant advances made in recent years on the technologies of implementing electromechanical micromirror devices as spatial light modulator, there are still limitations and difficulties when employing them to provide a high quality image display. Specifically, when the images are digitally controlled, the image quality is adversely affected due to the fact that the images are not displayed with a sufficient number of gray scales.

An electromechanical mirror device is drawing a considerable interest as a spatial light modulator (SLM). The electromechanical mirror device consists of “a mirror array” arranging a large number of mirror elements. In general, the mirror elements from 60,000 to several millions are arranged on a surface of a substrate in an electromechanical mirror device. Referring to FIG. 1A, an image display system 1 including a screen 2 is disclosed in a reference U.S. Pat. No. 5,214,420. A light source 10 is used for generating light energy for illuminating the screen 2. The generated light 9 is further concentrated and directed toward a lens 12 by a mirror 11. Lenses 12, 13 and 14 form a beam columnator operative to columnate light 9 into a column of light 8. A spatial light modulator (SLM) 15 is controlled on the basis of data input by a computer 19 via a bus 18 and selectively redirects the portions of light from a path 7 toward an enlarger lens 5 and onto screen 2. The SLM 15 has a mirror array arranging switchable reflective elements 17, 27, 37, and 47 being consisted of a mirror 32 connected by a hinge 30 on a surface 16 of a substrate in the electromechanical mirror device as shown in FIG. 1B. When the element 17 is in one position, a portion of the light from the path 7 is redirected along a path 6 to lens 5 where it is enlarged or spread along the path 4 to impinge on the screen 2 so as to form an illuminated pixel 3. When the element 17 is in another position, the light is not redirected toward screen 2 and hence the pixel 3 is dark.

Each of mirror elements constituting a mirror device to function as spatial light modulator (SLM), and each mirror element comprises a mirror and electrodes. A voltage applied to the electrode(s) generates a coulomb force between the mirror and the electrode, thereby making it possible to control and incline the mirror and the mirror is “deflected” according to a common term used in this specification for describing the operational condition of a mirror element.

When a voltage applied to the electrodes for controlling a mirror deflects a mirror, the deflected mirror also changes the direction of the reflected light in reflecting an incident light. The direction of the reflected light is changed in accordance with the deflection angle of the mirror. The present specification refers to a state of the mirror when a light of which almost the entirety of an incident light is reflected to a projection path designated for image display as an “ON light”, while referring to a light reflected to a direction other than the designated projection path for image display as an “OFF light”.

And a state of the mirror that reflects a light of an incident light in a manner that the ratio of the light reflected to a projection path (i.e., the ON light) and that reflected so as to shift from the projection path (i.e., the OFF light) is a specific ratio, that is, the light reflected to the projection path with a smaller quantity of light than the quantity of the state of the ON light is referred to as an “intermediate light”.

The terminology of present specification defines an angle of rotation along a clockwise (CW) direction as a positive (+) angle and that of counterclockwise (CCW) direction as negative (−) angle. A deflection angle is defined as zero degree (“0°”) when the mirror is in the initial state, as a reference of mirror deflection angle.

Most of the conventional image display devices such as the device disclosed in U.S. Pat. No. 5,214,420 implement a dual-state mirror control that controls the mirrors at a state of either ON or OFF. The quality of an image display is limited due to the limited number of gray scales. Specifically, in a conventional control circuit that applies a PWM (Pulse Width Modulation), the quality of the image is limited by the LSB (least significant bit) or the least pulse width as control related to the ON or OFF state. Since the mirror is controlled to operate in either the ON or OFF state, the conventional image display apparatus has no way to provide a pulse width to control the mirror that is shorter than the control duration allowable according to the LSB. The least quantity of light, which is determined on the basis of the gray scale, is the light reflected during the time duration according to the least pulse width. The limited gray scale leads to a degradation of the image.

Specifically, FIG. 1C exemplifies a control circuit for controlling a mirror element according to the disclosure made by a U.S. Pat. No. 5,285,407. The control circuit includes a memory cell 32. Various transistors are referred to as “M*” where “*” designates a transistor number, and each transistor is an insulated gate field effect transistor. Transistors M5 and M7 are p-channel transistors; while transistors M6, M8, and M9 are n-channel transistors. The capacitances C1 and C2 represent the capacitive loads in the memory cell 32. The memory cell 32 includes an access switch transistor M9 and a latch 32a, which is based on a Static Random Access Switch Memory (SRAM) design. The transistor M9 connected to a Row-line receives a DATA signal via a Bit-line. The memory cell 32 written data is accessed when the transistor M9 that has received the ROW signal on a Word-line is turned on. The latch 32a consists of two cross-coupled inverters, i.e., M5/M6 and M7/M8, which permit two stable states, that is, a state 1 is Node A high and Node B low, and a state 2 is Node A low and Node B high.

The mirror is driven by a voltage applied to the landing electrode abutting a landing electrode and is held at a predetermined deflection angle on the landing electrode. An elastic “landing chip” is formed at a portion on the landing electrode, which makes the landing electrode contact with mirror, and assists the operation for deflecting the mirror toward the opposite direction when a deflection of the mirror is switched. The landing chip is designed as having the same potential with the landing electrode, so that a shorting is prevented when the landing electrode is in contact with the mirror.

Each mirror formed on a device substrate has a square or rectangular shape and each side has a length of 10 to 15 um. In this configuration, a reflected light that is not controlled for purposefully applied for image display is however inadvertently generated by reflections through the gap between adjacent mirrors. The contrast of image display generated by adjacent mirrors is degraded due to the reflections generated not by the mirrors but by the gaps between the mirrors. As a result, a quality of the image display is worsened. In order to overcome such problems, the mirrors are arranged on a semiconductor wafer substrate with a layout to minimize the gaps between the mirrors. One mirror device is generally designed to include an appropriate number of mirror elements in, which each mirror element is manufactured as a deflectable micromirror on the substrate for displaying a pixel of an image. The appropriate number of elements for displaying image is in compliance with the display resolution standard according to a VESA Standard defined by Video Electronics Standards Association or the television broadcast standards. In the case in which the mirror device has a plurality of mirror elements corresponding to WXGA (resolution: 1280 by 768) defined by VESA, the pitch between the mirrors of the mirror device is 10 μm and the diagonal length of the mirror array is about 0.6 inches.

The control circuit as illustrated in FIG. 1C controls the micromirrors to switch between two states and the control circuit drives the mirror to oscillate to either an ON or OFF deflected angle (or position) as shown in FIG. 1A.

The minimum quantity of light controllable to reflect from each mirror element for image display, i.e., the resolution of gray scale of image display for a digitally controlled image display apparatus, is determined by the least length of time that the mirror controllable to hold at the ON position. The length of time that each mirror is controlled to hold at an ON position is in turn controlled by multiple bit words. FIG. 1D shows the “binary time periods” in the case of controlling SLM by four-bit words. As shown in FIG. 1D, the time periods have relative values of 1, 2, 4, and 8 that in turn determine the relative quantity of light of each of the four bits, where the “1” is least significant bit (LSB) and the “8” is the most significant bit. According to the PWM control mechanism, the minimum quantity of light that determines the resolution of the gray scale is a brightness controlled by using the “least significant bit” for holding the mirror at an ON position during a shortest controllable length of time.

FIGS. 2A and 2B are diagrams for illustrating the scales of grayscale. As illustrated in FIG. 2A, when adjacent image pixels are shown with great degree of different gray scales due to a very coarse scale of controllable gray scale, artifacts are shown between these adjacent image pixels. That leads to image degradations. The image degradations are specially pronounced in bright areas of display when there are “bigger gaps” of gray scales between adjacent image pixels. It was observed in an image of a woman that there were artifacts shown on the forehead, the sides of the nose and the upper aim. The artifacts are generated due to a technical limitation that the digitally controlled display does not provide sufficient gray scales.

FIG. 3A shows a picture for illustrating the degradation of display images due to a coarse grayscale. FIG. 3B shows a picture with typical grayscale, but it still shows some unnatural areas. At the bright spots of the display, e.g., the forehead, the sides of the nose and the upper arm, the adjacent pixels are displayed with visible gaps of light intensities. When the levels of gray scales are increased, the image degradation will be much less even with only twice more levels of gray scales as illustrated in FIG. 2A.

As the micromirrors are controlled to have a fully ON and fully OFF positions, the light intensity is determined by the length of time the micromirror is at the fully ON position. In order to increase the number of gray scales of a display, the speed of the micromirror must be increased such that the digital control signals can be increased to a higher number of bits. However, when the speed of the micromirrors is increased, a strong hinge is necessary for the micromirror to sustain a required number of operational cycles for a designated lifetime of operation. In order to drive the micromirrors supported on a further strengthened hinge, a higher voltage is required. The higher voltage may exceed twenty volts and may even be as high as thirty volts. The micromirrors manufactured by applying the CMOS technologies probably is not suitable for operation at such a high range of voltages and therefore the DMOS or High Voltage MOSFET technologies may be required. In order, to achieve higher degree of gray scale control, a more complicate manufacturing process and larger device areas are necessary when DMOS micromirror is implemented. Conventional modes of micromirror control are therefore facing a technical challenge that the gray scale accuracy must be sacrificed for the benefits of smaller and more cost effective micromirror display due to the operational voltage limitations.

There are many patents related to a light intensity control. These patents include U.S. Pat. Nos. 5,589,852, 6,232,963, 6,592,227, 6,648,476, and 6,819,064.

There are further patents and patent applications related to different shapes of light sources. These patents includes U.S. Pat. Nos. 5,442,414, 6,036,318 and Application 20030147052. The U.S. Pat. No. 6,746,123 discloses special polarized light sources for preventing light loss. However, these patents or patent application does not provide an effective solution to overcome the limitations caused by insufficient gray scales in the digitally controlled image display systems.

Furthermore, there are many patents related to spatial light modulation including U.S. Pat. Nos. 20,25,143, 2,682,010, 2,681,423, 4,087,810, 4,292,732, 4,405,209, 4,454,541, 4,592,628, 4,767,192, 4,842,396, 4,907,862, 5,214,420, 5,287,096, 5,506,597, and 5,489,952. However, these inventions have not addressed or provided direct resolutions for a person of ordinary skills in the art to overcome the above-discussed limitations and difficulties. Therefore, a need still exists in the art of image display systems applying digital control of a micromirror array as a spatial light modulator to provide new and improved systems such that the above-discussed difficulties can be resolved. The most difficulty to increase gray scale is that the conventional systems have only ON or OFF state and the minimum ON time cannot be reduced further because of limited driving voltage. The minimum ON time determines the height of the steps of gray scale as shown in FIG. 2A. There is no way to provide a difference of brightness lower than the step. If a difference of brightness lower than the step can be generated, the number of gray scales is increased and the degradation of picture quality will be improved substantially.

FIGS. 1A through 1D illustrate prior arts, and FIGS. 2A and 2B illustrate the definition of gray scale and the artifacts arising from low gray scale representation. FIG. 3A illustrates a sample of insufficient number of grayscales in which the degradation of picture quality is well noticeable. FIG. 4 illustrates an example of system diagrams of the present invention. This example has a 10-bit incoming signal, which is split into two parts, for example, upper 7 bits and lower 3 bits. The upper 7 bits are sent to the 1st state controller, the lower 3 bits are sent to the 2nd state controller and the sync signal is sent to the timing controller. The Selector shown in FIG. 4 selects the signals and feeds the upper bits during an ON/OFF mode and the lower bits during an intermediate mode.

An investigation on the effects of the variations caused by manufacturing inaccuracy has revealed that various actions must be taken to achieve an accurate control of brightness.

### SUMMARY OF THE INVENTION

One aspect of the present invention is to achieve a substantially higher number of grayscales for a micromirror device.

Another aspect of the present invention provides a display system, comprising: a) a display device having a plurality of mirrors and an oscillating state; and b) a processor processing an input video signal and controlling the display device, wherein the processor generates a control signal for controlling the individual mirrors constituting an image based on a value of at least either of a reflection light intensity L, or of an oscillation period T, of a predetermined mirror.

A second aspect of the present invention provides a display system, comprising: a) a display device which has a plurality of mirrors, and which has an ON state, an OFF state, and an oscillating state, of the mirror; and b) a processor processing an input video signal and controlling the display device, wherein the processor generates a control signal for controlling individual mirrors constituting an image based on a ratio of a light intensity obtained by oscillating a predetermined mirror in a duration of an oscillation period T to a light intensity obtained by putting the mirror in the ON state for a duration of the oscillation period T.

A third aspect of the present invention provides a control method for generating a gray scale by using a modulation of a mirror by putting it in an oscillating state in a display device having a plurality of mirrors and an oscillating state, comprising the steps of: a) inputting a video signal to a processor; b) calculating a time duration within a frame for performing a modulation by putting individual mirrors constituting an image in the oscillating state in accordance with the video signal on the basis of a value of a light intensity L, and/or that of an oscillation period T, of a predetermined mirror; and c) generating a control signal for controlling each of the mirrors constituting an image based on the calculated time duration for performing the modulation.

A fourth aspect of the present invention provides a control method for generating a gray scale by using a modulation of a mirror by putting it in an oscillating state in a display device having a plurality of mirrors and an oscillating state, comprising the steps of: a) inputting a video signal to a processor; b) calculating a time duration within a frame for performing a modulation by putting each of the mirrors constituting an image in the oscillating state in accordance with the video signal on the basis of the ratio of a light intensity obtained by oscillating a predetermined mirror in an oscillation period T to a light intensity obtained by putting the mirror in an ON state for a duration of the oscillation period T; and c) generating a control signal for controlling each of the mirrors constituting an image based on the calculated time duration for performing the modulation.

For instance, the principle of the embodiments of the present invention is to introduce intermediate states, which output sub-LSB brightness, and to establish methods for driving micromirrors in the intermediate states. The present invention can provide 16 times higher number of grayscales than conventional micromirror systems.

To minimize the effects caused by the manufacturing inaccuracy of micromirror devices, a time-base control system of intermediate states has been developed, which minimizes the effects to the brightness at sub-LSB region.

The computerized simulation has indicated that the use of design variations or the measured average of products are very effective to determine the pre-fixed driving times.

### BRIEF DESCRIPTION OF THE DRAWINGS

The above-noted objects of the present invention and other objects will become apparent from the following detailed description and claims when read in conjunction with the accompanying drawings wherein:

FIGS. 1A and 1B show a prior art illustrating the basic principle of a projection display using a micromirror device;

FIG. 1C shows an example of the driving circuit of prior arts;

FIG. 1D shows the scheme of Binary Pulse Width Modulation (Binary PWM) of conventional digital micromirrors for generating a grayscale;

FIG. 2A shows an example of an insufficient number of grayscales where the minimum step of brightness change is very large and the artifacts are very visible;

FIG. 2B shows an example of an improved grayscale where the artifacts are less visible;

FIG. 3A shows an example of a picture having an insufficient number of grayscales and well visible artifacts;

FIG. 3B shows an example of the same picture with an improved grayscale;

FIG. 4 illustrates an example of a system diagram according to the present invention;

FIG. 5 is a conceptual diagram exemplifying a configuration of a pixel unit 211 constituting a spatial light modulation element according to a preferred embodiment of the present invention;

FIG. 6 is an alternative control circuit diagram for showing two transistor arrays with one column of lines for two electrodes;

FIG. 7A illustrates an example of a micromirror at an ON state which reflects incoming light fully;

FIG. 7B illustrates an example of a micromirror at an OFF state which does not reflect incoming light;

FIG. 7C illustrates an example of a micromirror at an oscillation state which reflects incoming light partially;

FIG. 8 is a flow chart exemplifying a preparation process at a display system according to the embodiment of the present invention;

FIG. 9 is a flow chart exemplifying an operation of a display system according to the embodiment of the present invention;

FIG. 10A illustrates an example of micromirror in an oscillating state which reflects ¼ of the light reflected by the mirror at a full ON position;

FIG. 10B illustrates another example of micromirror at the oscillating states which reflect ¾ (left pulses) and ¼ (right pulses) of the incoming light;

FIG. 11A illustrates an example of obtaining 1/16 of the light intensity of the full ON position;

FIG. 11B illustrates an example of driving a micromirror from the OFF position to obtain 1/16 of the light intensity;

FIG. 11C illustrates an example of driving a micromirror from the ON position to obtain 1/16 of the light intensity;

FIG. 12A illustrates an example of the mirror movement and time of applying a drive voltage, when the hinge of the mirror is weaker than the manufacturing norm;

FIG. 12B illustrates an example of the mirror movement and time of applying a drive voltage, when the strength of the hinge of the mirror is at the manufacturing norm;

FIG. 12C illustrates an example of the mirror movement and time of applying a drive voltage, when the hinge of the mirror is stronger than the manufacturing norm;

FIG. 13A illustrates an example of the multiple mirror movements, when the hinge of the mirror is weaker than the manufacturing norm and the driving voltage is applied at a fixed time;

FIG. 13B illustrates an example of the multiple mirror movements, when the hinge of the mirror is stronger than the manufacturing norm and the driving voltage is applied at a fixed time;

FIG. 14 is a conceptual diagram showing a configuration of a projection apparatus of a single plate system according to a preferred embodiment of the present invention;

FIG. 15 is a conceptual diagram showing a configuration of a projection apparatus of a multiple plate system according to another preferred embodiment of the present invention;

FIG. 16A is a side view diagram of a synthesis optical system of a projection apparatus according to the preferred embodiment of the present invention;

FIG. 16B is a front view diagram of a synthesis optical system of a projection apparatus according to the preferred embodiment of the present invention;

FIG. 16C is a rear view diagram of a synthesis optical system of a projection apparatus according to the preferred embodiment of the present invention; and

FIG. 16D is an upper plain view diagram of a synthesis optical system of a projection apparatus according to the preferred embodiment of the present invention.

### DESCRIPTION OF THE PREFERRED EMBODIMENTS

One aspect of the present invention is to achieve a substantially higher number of grayscales for a micromirror device. The principle of the embodiments of the present invention is to introduce intermediate states to control the projection of sub-LSB brightness and to establish methods for driving the micromirrors to operate in the intermediate states.

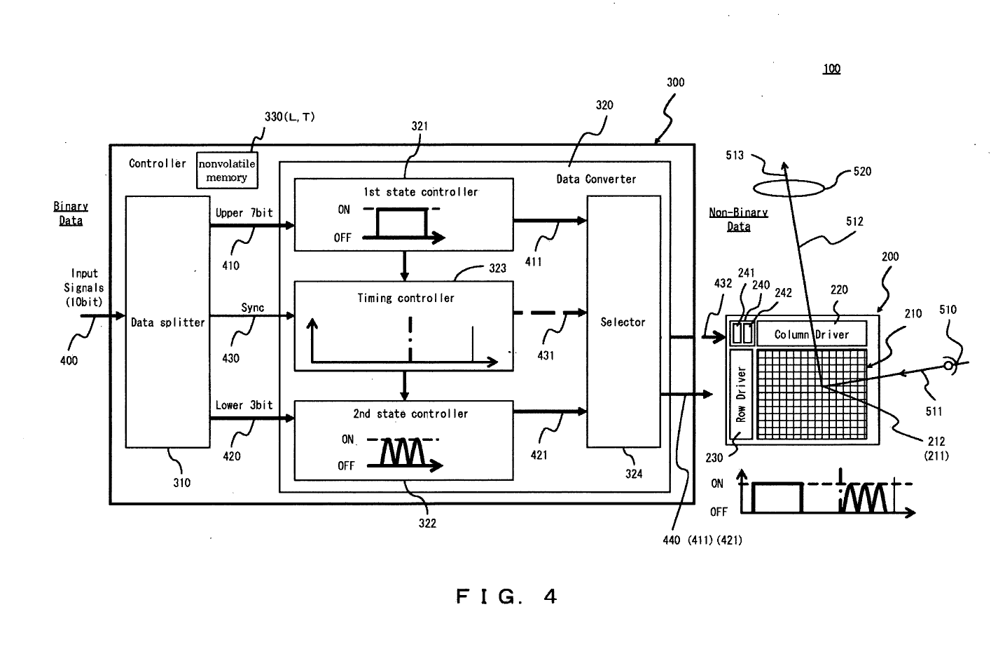

For the purpose of describing the novel features of this invention, reference is now made to the above listed Figures for the purpose of describing, in detail, the preferred embodiments of the present invention. The Figures referred to and the accompanying descriptions are provided only as examples of the invention and are not intended in anyway to limit the scope of the claims appended to the detailed description of the embodiment. The novel aspects of the present invention will now be described in conjunction with and by referring to FIGS. 4 through 16D.

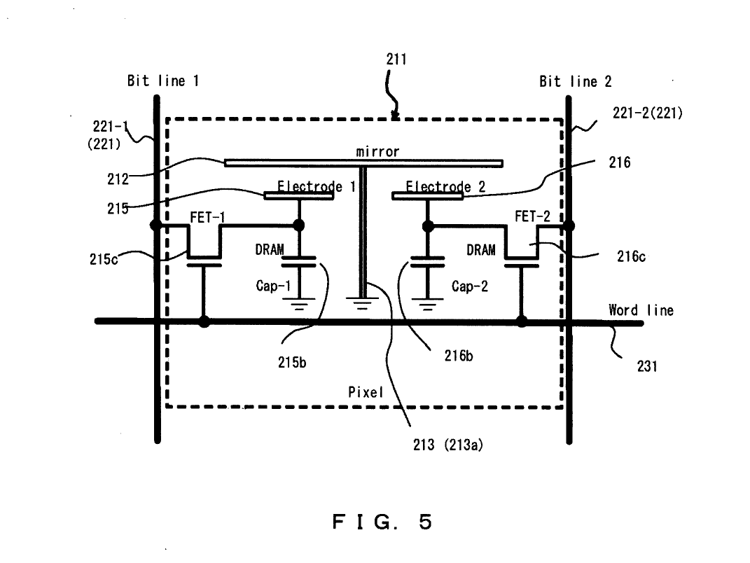

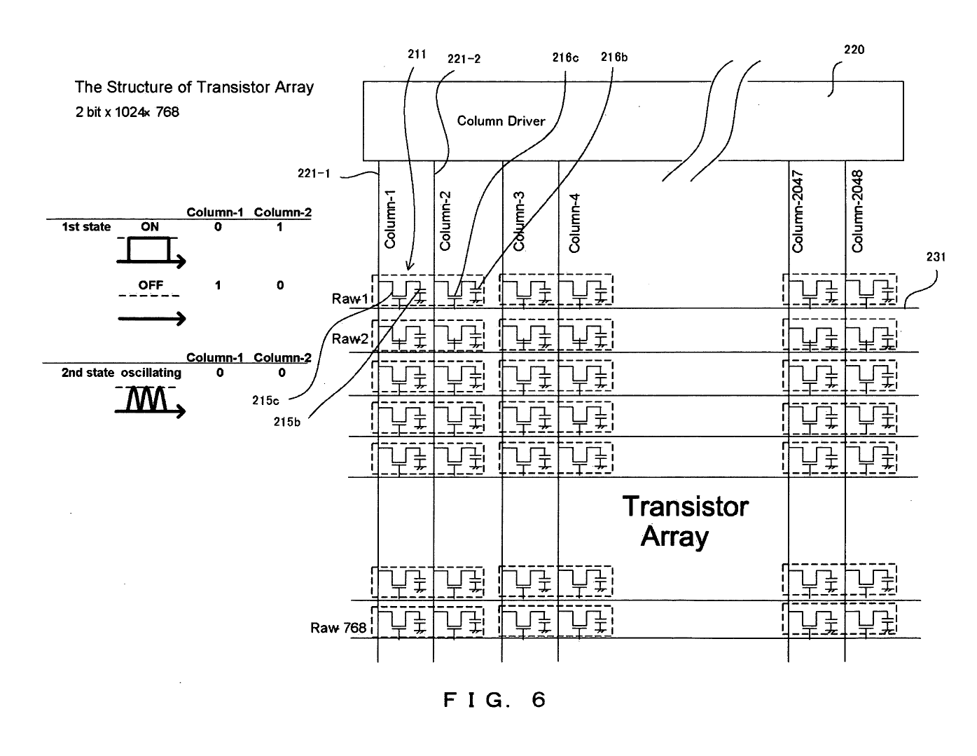

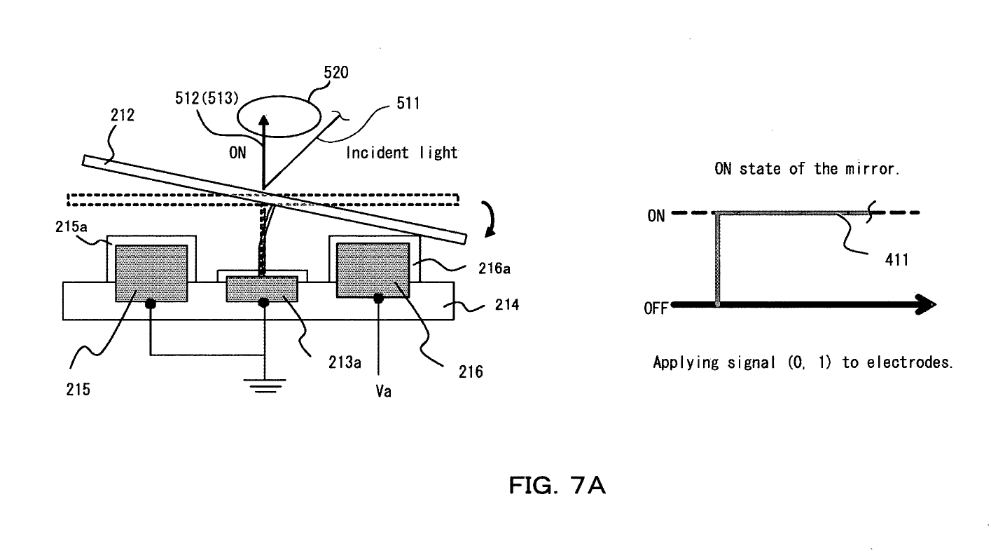

FIG. 5 is a functional diagram for illustrating a system configuration of a pixel unit implemented as a spatial light modulation element according to the present embodiment. FIG. 4 shows a display system 100 includes a spatial light modulation element 200, a control apparatus 300, a light source 510 and a projection optical system 520. FIGS. 5 and 6 show the spatial light modulation element 200 comprises a pixel array 210, a column driver 220, a row driver 230, and an external interface unit 240. In FIG. 6, the spatial light modulation element 200 includes a column driver 220 to control two bit lines 221-1 and 221-2 for controlling the pixels units 211. A plurality of pixel units 211 are arrayed in a grid and disposed at the pre-designated intersections of the vertical bit line 221 with a horizontal word line 231. The bit lines are controlled by a column drive 220 and a row driver 230 controls the word lines.

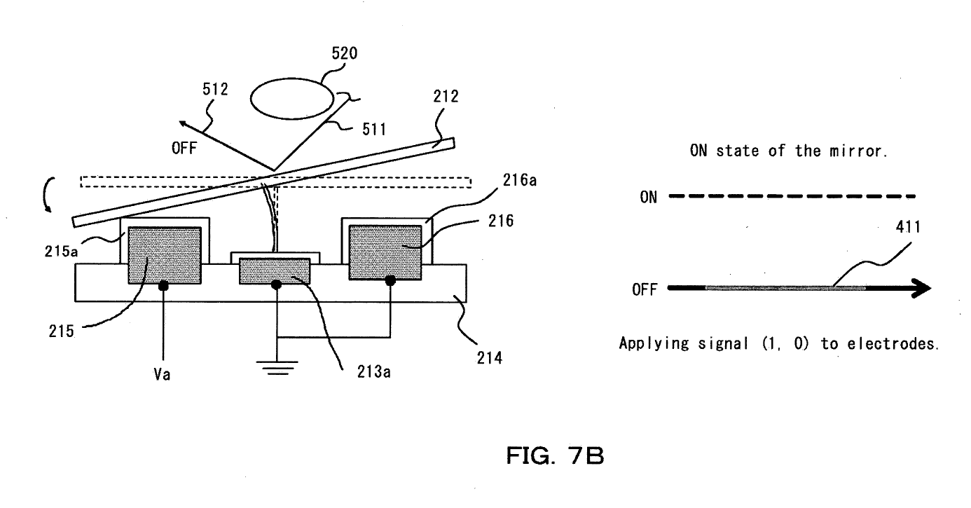

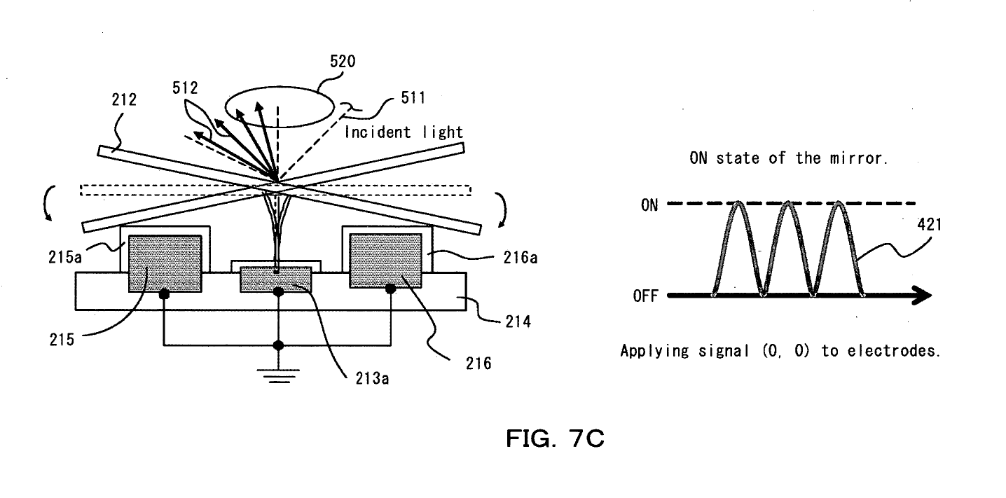

Referring to FIGS. 5, 7A, 7B and 7C for the pixel units 211 and the specific operational details of the micromirror 212 that is supported on a vertical hinge 213 formed on a substrate 214. The hinge 213 is a flexibly deflectable hinge to allow the micromirror 212 to tilt to different inclining angles. There are an OFF electrode 215 including an OFF stopper 215a and an ON electrode 216 including an ON stopper 216a symmetrically disposed on two opposite sides of the hinge 213 on the substrate 214. The hinge 213 further includes a hinge electrode 213a disposed near the bottom of the hinge in the middle portion on the substrate 214 between the ON and OFF electrodes.

By applying a prescribed voltage to the OFF electrode 215 the coulomb force generated between the OFF electrode and the mirror draws the micromirror 212 to tilt to an angular position physically contacting the OFF stopper 215a. When controlled to move to this OFF position, the micromirror 212 reflects an incident light 511 to a light path that is directed away from the optical axis of the projection optical system 130.

By applying a prescribed voltage to the ON electrode 216, the coulomb force generated between the OFF electrode and the mirror draws the micromirror 212 to tilt to an angular position physically contacting the ON stopper 216a. When controlled to move to this ON position, the micromirror 212 reflects an incident light 511 to a light path directed to a direction matching with the optical axis of the projection optical system 520.

An OFF capacitor 215b is connected to the OFF electrode 215 and to the bit line 221-1 by way of a gate transistor 215c. An ON capacitor 216b is connected to the ON electrode 216, and to the bit line 221-2 by way of a gate transistor 216c. The word line 231 controls and sends a signal to turn on and off the transistor 215c. Specifically, a horizontal row of the pixel units 211 in line with an arbitrary word line 231 is simultaneously selected. The bit lines 221-1 and 221-2 control the charge and discharge of capacitance to and from the OFF capacitor 215b and ON capacitor 216b. The signals transmitted through the word line and bit line therefore control the micromirrors 212 in each of the pixel units 211 in one horizontal row.

The external interface unit 240 includes a timing controller 241 and a parallel/serial interface 242. The timing controller 241 selects a horizontal row of the pixel units 211 sending a signal through the word line 231 based on a scan timing control signal 432. The parallel/serial interface 242 supplies the column driver 220 with a modulation control signal 440.

The light source 510 projects an incident light 511 to the spatial light modulation element 200. The incident light 511 is reflected from micromirrors 212 as a reflection light 512 for projecting to the projection optical system 520. The reflection light 512 when projected along the light path coincides with the projection light 513 is projected onto a screen to display an image on the screen (not shown).

The control apparatus 300 on this exemplary embodiment controls the spatial light modulation element 200. The controller 300 comprises a data splitter 310, a data converter 320 and nonvolatile memory 330. Furthermore, the controller 300 controls the gray scales of the image display by controlling and modulating the micromirrors 512 to operate in an ON, OFF and oscillating states. The nonvolatile memory 330 stores the data including the intensity of reflection light L, the oscillation period T and all data related to a selected micromirrors 212 for controlling and operating the spatial light modulation element 200. Specifically, the control apparatus 300 controls the ON/OFF and an oscillating state of the micromirror 212 of the spatial light modulation element 200 as described below. The controller 300 controls the micromirrors by using the data of the reflection light intensity L and oscillation period T stored in the nonvolatile memory 330 to control the gray scale of display.

The data splitter 310 receives a binary video signal 400 as input binary data and carries out the function of separating the binary video into separation data 410 for controlling the micromirror 212. The data 410 is applied to operate the micromirrors under an ON/OFF modulation. The data 420 is applied for controlling the micromirror 212 to operate in an oscillating state. The controller further issues a synchronous signal 430 for controlling the data converter 320. The data converter 320 comprises a first state control unit 321, a second state control unit 322, a timing control unit 323 and a selector 324. The first state-control unit 321 carries out the function of generating a first mirror control signal 411 based on the separation data 410. The selector 324 then selectively applies the first mirror control signal 411 as the binary data to the spatial light modulation element 200 for controlling the micromirrors 212 to operate in the ON/OFF states. The second state-control unit 322 carries out the function of generating a second mirror control signal 421 as the non-binary data. The second mirror control signal is generated based on the data of the separation data 420, the reflection light intensity L and oscillation period T stored in the nonvolatile memory 330. The selector 424 then selectively applies the second mirror control signal to the spatial light modulation element 200 for controlling the micromirror 212 to operate in an oscillating state. More specifically, operation parameters such as T1, T2 and Tosc are controlled and set by the controller as will be further described below.

The timing control unit 323 performs the function of controlling the first state control unit 321 and second state control unit 322. The timing control unit 323 calculates the time duration to control the micromirror 212 in an ON state within each frame corresponding to the binary video image signal 400. The timing control unit 323 further calculates the time duration to control the micromirror 212 in an oscillating state for each of the micromirrors 212 for the image pixels based on a synchronous signal 430 generated from the input binary video image signal 400, or according to a synchronous signal received simultaneously with a video image signal. The timing control unite further performs a function of outputting a switchover control signal 431 to the selector 324.

The selector 324 selects either the first mirror control signal 411 or the second mirror control signal 421 for applying to the spatial light modulation element 200 based on the switchover control signal 431. The selector therefore switches the control of the micromirror 212 from an ON/OFF modulation control of the first state control unit 321 applying the first mirror control signal 411 over to an oscillation modulation control by selecting the second state control unit 322 applying the second mirror control signal 421, or from the oscillation modulation control over to the ON/OFF modulation control. Although the data splitter 310, data converter 320, first state control unit 321, second state control unit 322, timing control unit 323 and selector 324 shown in the drawing as separate function units individually, all these functions may be combined and integrated as a single function unit to carry out all these functions.

Each of the pixel elements, i.e., the pixel units 211, of the spatial light modulation element 200 includes a micromirror 212 controlled in one of the states, i.e., the ON/OFF state, an oscillating state or an intermediate state. The present embodiment is configured to control the ON/OFF state by the first mirror control signal 411 from the first state control unit 321 and the oscillating state and intermediate state controlled by the second mirror control signal 421 from the second state control unit 322. The spatial light modulation element 200 carries out a light intensity (i.e., an intensity of light) modulation according to the length of interval of the first mirror control signal 411 and second mirror control signal 421, and further based on a control timing requirement according to an arithmetic logical operation.

The following description describes the basic control of the micromirror 212 of the spatial light modulation element 200 according to the present embodiment. A function defined by Va (1,0) represents an application of a predetermined voltage Va to the OFF electrode 215 and in the meantime the ON electrode 216 is left open without applying a definite voltage. On the other hand a voltage function defined by Va (0,1) represents that no voltage is applied to the OFF electrode 215 and a voltage Va is applied to the ON electrode 216. Furthermore, a voltage function defined by Va (0,0) represents that there is no voltage applied to either the OFF electrode 215 or the ON electrode 216 and Va (1,1) represent a high voltage Va is applied to both of the OFF electrode 215 and ON electrode 216.

FIGS. 7A, 7B and 7C show a configuration of the pixel unit 211 comprising the micromirror 212, hinge 213, OFF electrode 215 and ON electrode 216, and voltage diagrams for controlling the state of the micromirror 212 to operate in an ON/OFF state and in an oscillating state. FIG. 7A shows the micromirror 212 is drawn by a ON electrode 216 to incline from the neutral state to an ON state by applying a predetermined voltage (i.e., Va (0,1)) to only the ON electrode 216. When the micromirror 212 is positioned in the ON state, the reflection light 512 from the micromirror is captured by the projection optical system 520 and projected as a projection light 513. The right side of FIG. 7A is a diagram for showing the intensity of light projected in the ON state.

FIG. 7B shows the micromirror 212 is drawn the OFF electrode 215 to incline from the neutral state to an OFF state by applying a predetermined voltage (i.e., Va (1,0)) to only the OFF electrode 215. The micromirror 212 operate in the OFF state directs the reflection light 512 away from the projection optical system 520. The reflection light is not applied as part of the image projection light 513. The right side of FIG. 7B is a diagram for showing the intensity of light projected in the OFF state.

FIG. 7C shows the micromirror 212 is operated in a state of free oscillation with a maximum range represent by A0 with the voltage applied to the electrodes represented by Va (0,0). The micromirror oscillates between an angular position of full ON when the micromirror is in contact with the ON electrode 216 and another angular as the micromirror is in contact with the OFF electrode 215.

As an incident light 511 is projected on the micromirror 212 at a prescribed angle and the micromirror is operated at oscillating states, the intensity of the reflecting light direct to the projection system for image display is also oscillating. The diagram on the right side of FIG. 7C shows the oscillation of the light intensity projected by an oscillating micromirror to the projection system for image display.

In FIG. 7A, the micromirror is operated in an ON state and the total light flux of the reflected reflection light 512 reflected along the ON direction is captured almost entirely by the projection optical system 520 and projected as the projection light 513.

In FIG. 7B, when the micromirror is operated in the OFF state, the reflection light 512 is directed to an OFF direction away from the projection optical system 520.

In FIG. 7C, when the micromirror 212 is operated in the oscillating state, a part of the light flux of the reflection light 512, diffraction light, diffusion light and the like are captured by the projection optical system 520 and projected as a projection light 513 and the light intensity changes temporally as shown on the right side of FIG. 7C.

Note that the examples shown in FIGS. 7A, 7B and 7C described above have been described for a case of applying the voltage Va represented by a binary value of “0” or “1” to each of the OFF electrode 215 and ON electrode 216. Alternatively, however, a more minute control of a swinging angle of the micromirror 212 is possible by increasing the steps of coulomb force generated between the OFF electrode 215 and ON electrode 216 by increasing the step of the voltage value Va to multiple values. Also note that the examples shown in FIGS. 7A, 7B and 7C described above have been described for a case of making the micromirror 212 (i.e., the hinge electrode 213a) at the ground potential; alternatively, however, a more minute control of a swinging angle of the micromirror 212 by applying an offset voltage thereto is possible.

The present embodiment is configured to apply the voltages, i.e., Va (0,1), Va (1,0) and Va (0,0), at the respective appropriate timings in the middle of the oscillation of the micromirror 212 between the ON and OFF states. Free oscillations of amplitudes A1 and A2 that are smaller than the maximum amplitude A0 between the ON and OFF states will be described below to provide more minute control of the gray scales of image display.

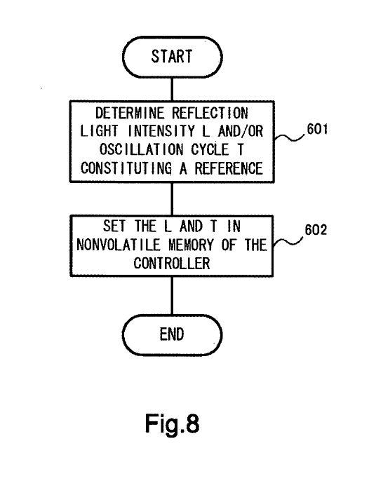

FIG. 8 is a flow chart for illustrating a preparation process at a display system 100 according to another embodiment. The display system 100 according to the present embodiment is configured to perform the process for setting the reflection light intensity L and oscillation period T described above and these parameters are stored in the nonvolatile memory 330 as part of the control apparatus 300. In step 601, one of the parameters of either the reflection light intensity L or the oscillation period T is determined. In step 602, either one of these two parameters is written to the nonvolatile memory 330.

In the process of determining the reflection light intensity L and oscillation period T in the step 601, a computational process is performed to calculate the values of the reflection light intensity L and oscillation period T by taking into consideration of the design values of the material properties, sizes, forms and such of the hinge 213 and micromirror 212 of a plurality of pixel units 211 constituting the pixel array 210. Alternately, measurements of the reflection light intensity and oscillation cycle at one or plurality of pixel units 211 can be performed. The measurement may be carried out in the center part of the zone with array of a plurality of pixel units 211 as part of the pixel array 210. The measured values of the reflection light intensity L and oscillation period T may be used as reference operational parameters stored in the nonvolatile memory. Specifically, the reflection light intensity L is measured by setting up a specific optical system, a reflection light of an ON direction obtained by illuminating the micromirror 212 of the measurement subject with a laser light of a known intensity. It is also feasible to use an oscilloscope or similar measurement instruments to measure the oscillation cycle of the micromirror 212 and applying the measurements for calculating the oscillation period T.

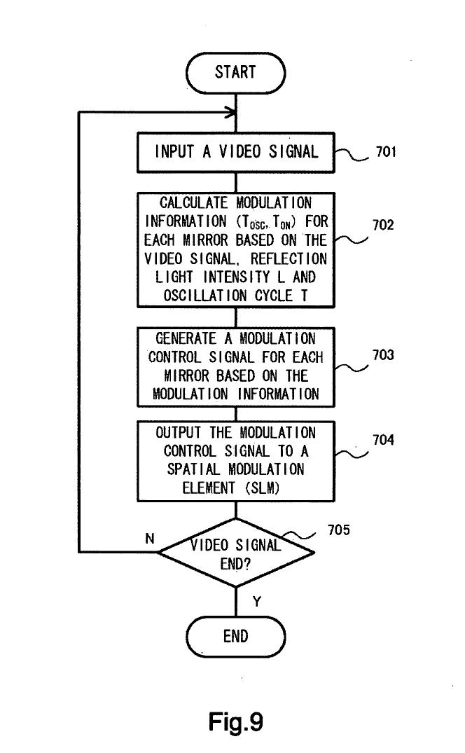

FIG. 9 is a flow chart for illustrating an operation process of the display system 100 according to the present embodiment. In step 701, a binary video signal 400 is input to the control apparatus 300. In step 702, the modulation parameters for each micromirrors 212 are calculated. The modulation parameters may include a time duration Ton for operating the micromirror 212 in an ON state within a video image frame of a binary video signal and a time duration Tosc for controlling the micromirror 212 in an oscillating state for each micromirror 212 for displaying an image based on the binary video signal 400. The calculations use the parameters of the reflection light intensity L and oscillation period T stored in the nonvolatile memory 330. In step 702, the time duration Ton is calculated based on the non-binary data generated from the separation binary data 410. Specifically, the time of a bit string that is configured to have continuous bit “1” is applied with the same weight as that of the LSB of the binary data for the number of the decimal value of the separation data 410 is set as the time Ton.

The time duration Tosc for operating the micromirror 212 in an oscillating state is calculated by using the ratio of a light intensity obtained by oscillating a selected mirror in the oscillation period T to the light intensity obtained by operating the mirror in the ON state for a duration of the oscillation period T. Also, the first state control unit 321 and second state control unit 322 respectively generate the first mirror control signal 411 and second mirror control signal 421 for each micromirrors 212 for projecting an image by using the modulation information such as the calculated time Ton and time Tosc (step 703).

In step 704 the first mirror control signal 411 and second mirror control signal 421 are outputted to the spatial light modulation element 200 for controlling the micromirrors 212 of the plurality of pixel units 211 to project an image as a pixel array 210. The processes of the steps 701 through 704 described above are repeated until the althea binary video signal 400 are completely processed (step 705).

The method for calculating the time Tosc based on the reflection light intensity L carried out in the step 702 is described below.

(1) A Calculation Method Using a Reflection Light Intensity L

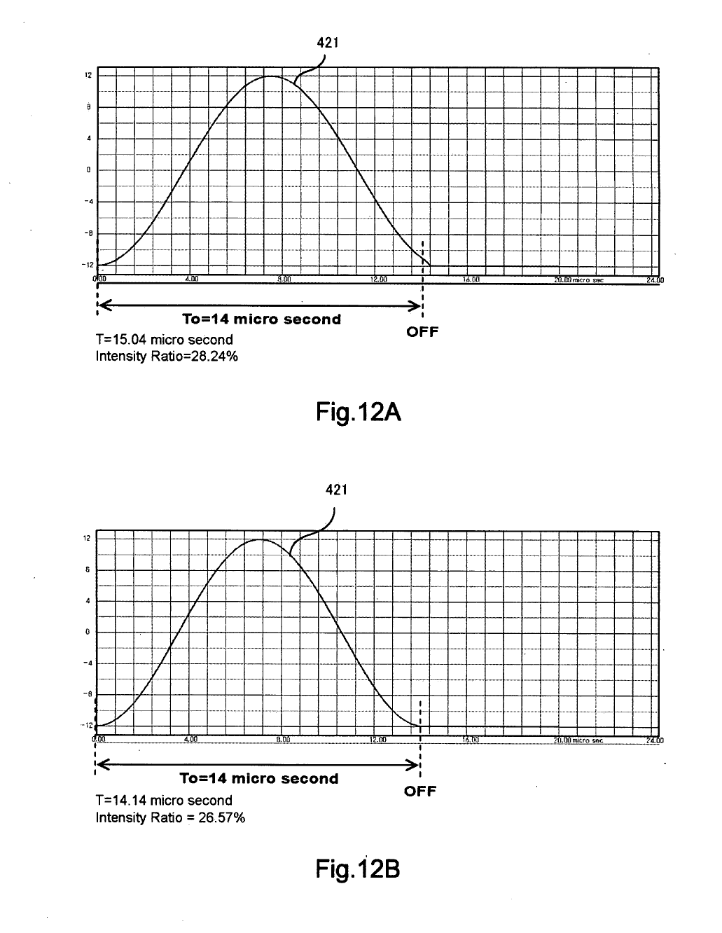

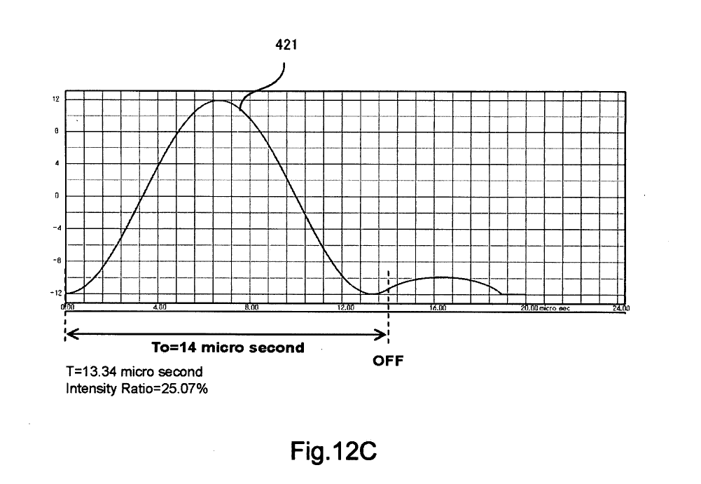

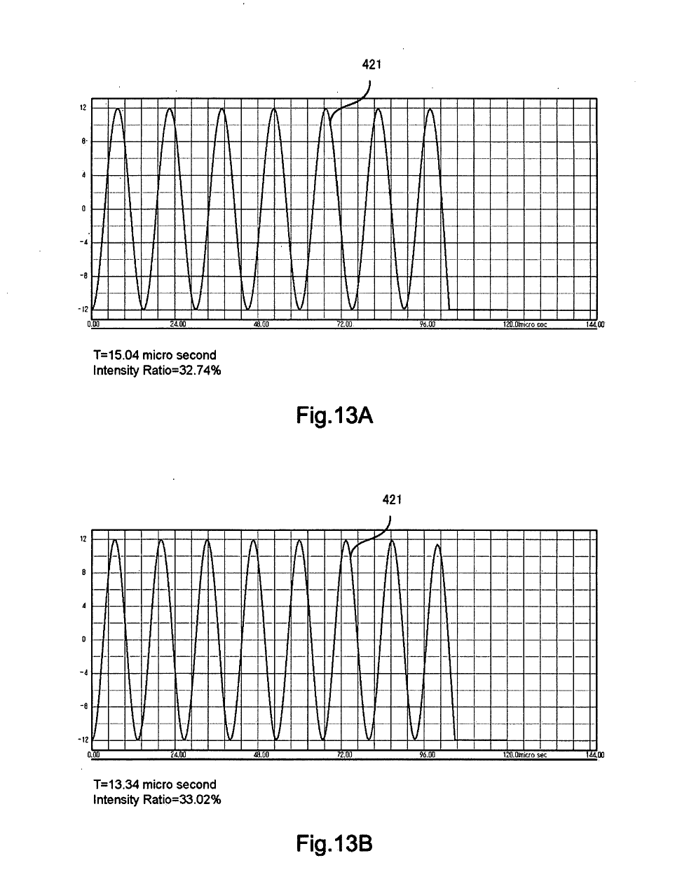

As described below in FIGS. 12A through 12C and FIGS. 13A through 13B, when the number of oscillations of a mirror is large enough, the light intensity can be controlled by controlling the time to carry out an oscillation modulation. Under this circumstances, where “L” is the light intensity controllable through an oscillation modulation by controlling a selected micromirror 212 through a reference for a period Tm. The light intensity L projected from the micromirror 212 is computed in the unit of time according to formula as L/Tm.

In order to project alight with a light intensity L1 by an oscillation modulation of the mirror, the time for the necessary oscillation modulation is T1 based on the following expression [1]:
T1=L1/L*Tm [Equation 1]

The T1 in Equation 1 is used, as Tosc, for controlling all the micromirrors 212 in order to form a video image.

(2) A Calculation Method Using an Oscillation Period T

A selected mirror has an oscillation cycle represented by a time duration “To” and “Tf” is a total control time allowing an oscillation modulation of the micromirror 212 within one video image frame. The maximum number of oscillation of the micromirror 212 with the total control time Tf is Tf/To.

Here, if Tf/To is equal to or greater than “256” for example, a control mechanism for controlling the micromirror oscillations from “0 through 256” cycles within one frame period makes it possible to control the light intensity to generate 256 (i.e., 8 bits) gray scales.

Assuming that “m” is a desired number of gray scales; then the time T2 required to oscillate the micromirror 212 in order to generate the controllable number of gray scales can be defined as:
T2=m*To (where 0≦m≦256) [Equation 2]

T2 in Equation 2 is the oscillation time Tosc of the micromirror 212 in order to generate controllable incremental light intensity to project an image with approximately m-gray scales.

The brightness of a mirror output is determined by Equation 3 described below:
Minimum Controllable Brightness Adjustment=Intensity of incoming light*Reflectance*LSB (time)*F [Equation 3];

Where F is an optical coefficient related to a projection lens, et cetera

For high quality image display, it is desirable to have as high intensity of incoming light as possible for projecting a brighter image. The LSB time slice has been reduced to be as short as possible. The further improvement requires a substantially higher driving voltage, which is not feasible for commercial and practical reasons. However, there is one more adjustable parameter left to reduce the minimum adjustable brightness by dynamically changing the reflectance of mirrors.

FIGS. 7A and 7B show an optical system that changes the reflectance of the mirror by changing the mirror angles for reflecting the light to an ON direction. The ON position of a mirror is usually designed as the position that provides the maximum brightness and the OFF position is to provide the minimum brightness within the drivable range of angles. By keeping the mirrors in the condition of reflecting the light partially, it is possible to obtain a sub-LSB brightness and increase the number of grayscales. In conventional systems, a mirror is driven to an ON position with (0,1) signal to the electrodes disposed beneath the mirror, where the signal (0,1) is defined as zero volt applied to the left electrode and an ON voltage applied to the right electrode as illustrated in FIG. 7A. A signal (1, 0) is applied to drive the mirror to an OFF position.

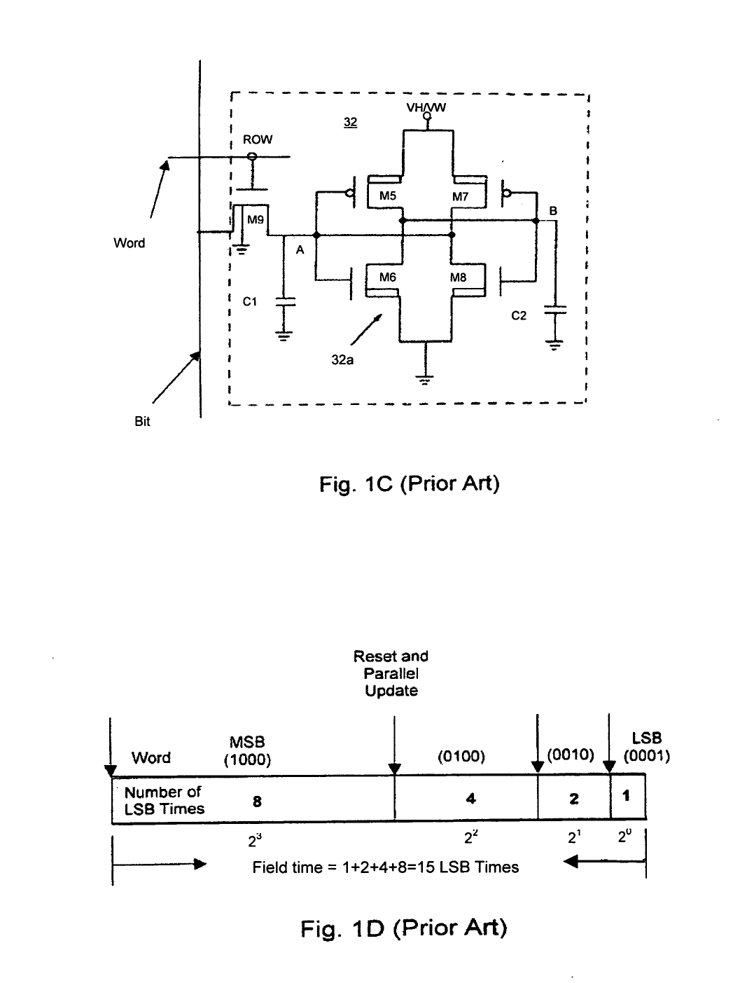

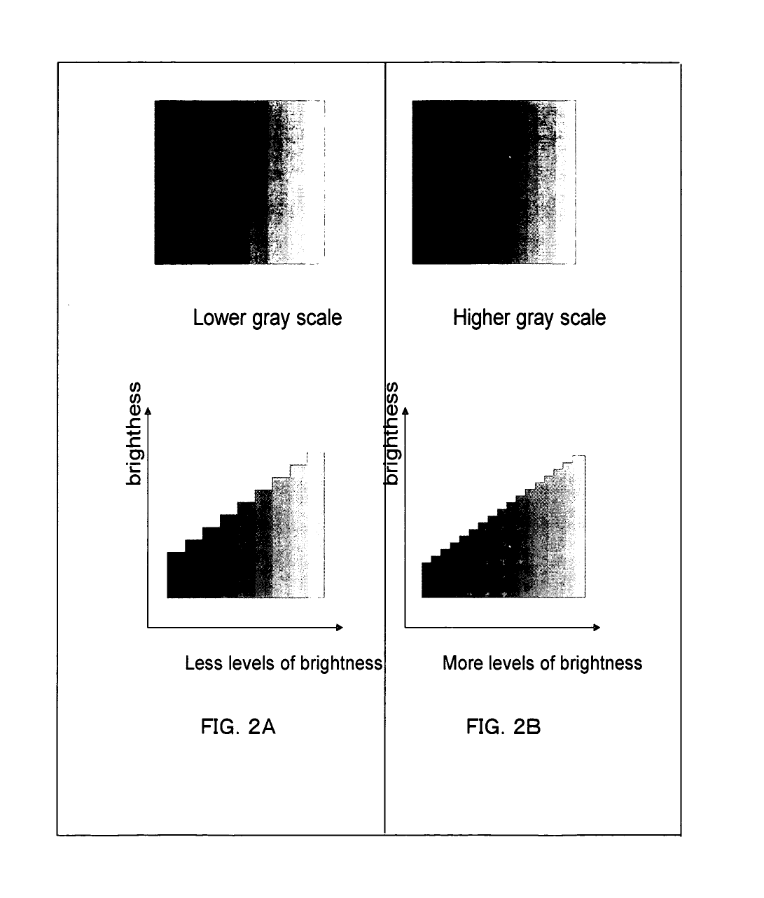

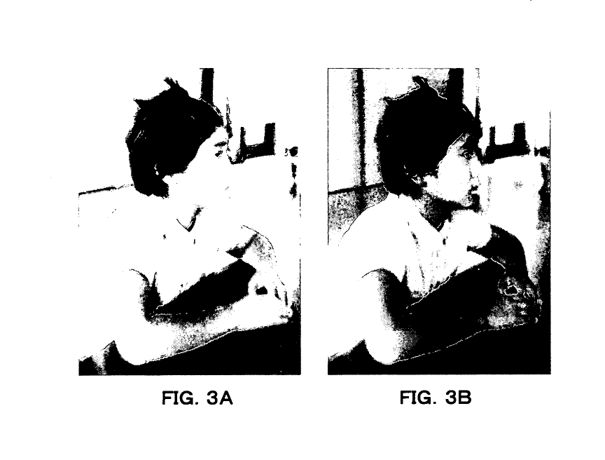

As illustrated in FIG. 7C, if a mirror is kept in an oscillating condition, a light intensity below that of ON position is generated. This can be achieved by providing two electrodes under the mirror with zero volts, or (0, 0), when the mirror is in the position of ON or OFF state. The driving circuit shown in FIG. 1C is not able to achieve the oscillation state due to the fact that it is necessary to apply a multi-bit input system instead. Various computerized simulations have concluded that the average reflectance is from 20% to 40% is reflected from an oscillating mirror depending on optical configurations. If an optical system is suitably selected, the adjustable reflectance can be reduced to 25%, or ¼ of the amount of a fully ON reflectance.

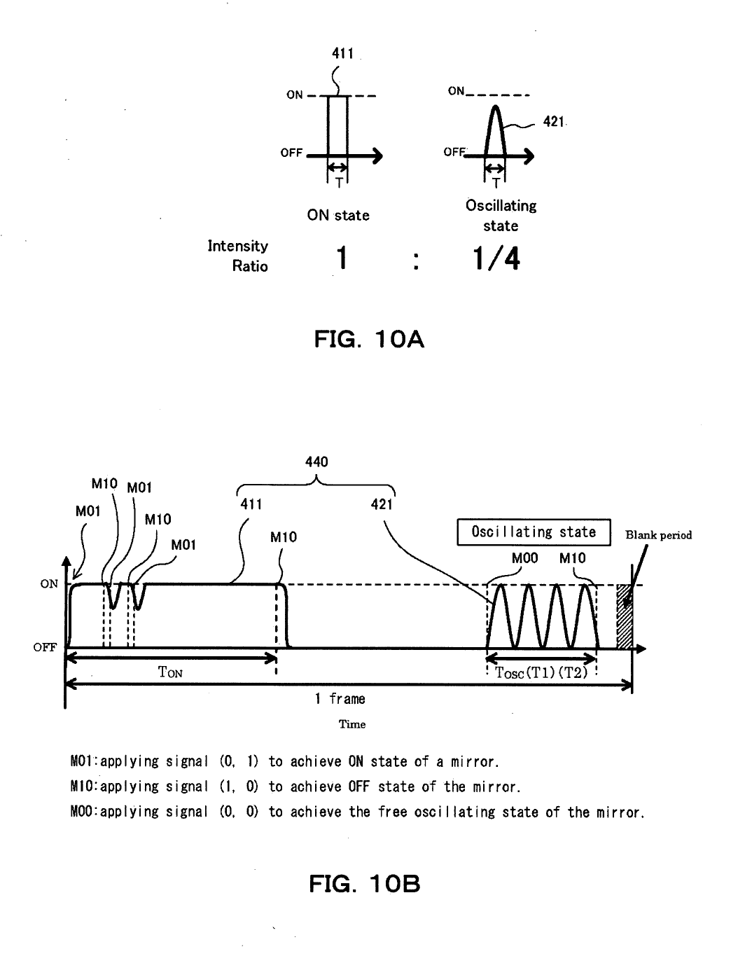

By controlling and oscillating the micromirrors enables the optical systems of this invention to obtain ¼ of output brightness without changing the intensity of incoming light as illustrated in FIG. 10A.

FIG. 10A illustrates the ratio of a light intensity reflected by one oscillation (i.e., an oscillation period T) of the micromirror 212 to a light intensity reflected from the micromirror operated in an ON state for the same time (i.e., an oscillation period T). The ratio is about 1 to 4; the oscillating mirror reflects a light with approximately ¼ (25%) of light intensity.

By controlling the length of time for the micromirror to stay at an ON state enables an image project system to project an image with an adjustable gray scales, such as 256-gray scales (i.e., of 8-bit). By combining the pulse width modulation control with mirror oscillation control will further enable the image projection system to display image with a higher number of gray scales, such as 1024 gray scales, i.e., equivalent to a 10 bits of gray scale control.

FIG. 10B illustrates a control diagram by applying multiple pulses to the electrodes disposed under the mirror Multiple dips are shown in the middle of an ON state with the intensity drops to an approximately ¾ of the full intensity. These drops of intensity are generated by apply pulses to pull back the mirror toward the OFF position partially and return the mirror to the ON position.

In order to apply the modulation control signal 440 shown in FIG. 10B, the second mirror control signal 421 is applied for operating the mirror in the oscillating state by the performing following procedures:

(1) Applying a signal (0, 0) to start oscillating (i.e., the control operation M00) from an OFF state of the mirror;

(2) Continuing to apply the signal (0, 0) during the oscillation period (i.e., Tosc), by maintaining the control operation M00; and

(3) After the last oscillation and the mirror reaching the maximum inclination angle, applying the control operation M01 by applying a signal (1, 0) at the time when the mirror is moving to the other side to control the mirror to move to an OFF state.

The oscillation control time Tosc is calculated based on a light intensity calculated with a ratio of a light intensity. The ratio of the light intensity is obtained by dividing the light intensity projected in one oscillation of a standard micromirror 212 by the light intensity reflected form the micromirror 212 operated in an ON state for a time duration equals to one oscillation of the micromirror 212.

The light intensity reflected from the micromirror in one oscillation is determined by various parameters such as the thickness and material of the hinge 213 of the micromirror 212, the size and weight of the micromirror 212, and the coulomb forces generated between the micromirror 212 and OFF electrode 215 and between the micromirror 212 and ON electrode 216. Change the light intensity to change the second control signal 421 is achievable by modifying these parameters.

Referring to FIG. 10B again, the first mirror control signal 411 of the modulation control signal 440 applies a first control signal M01 when the micromirror 212 is operated in the ON state. The control operation M10 is repeated twice in a short time interval until the micromirror 212 is eventually controlled to operate in the OFF state by executing the control operation M10.

The operation process reduces the light intensity to ¾ (75%) in two short periods in the time slices when the control operation of M10 is applied. These control processes enable the image projection system to display the images with additional gray scales.

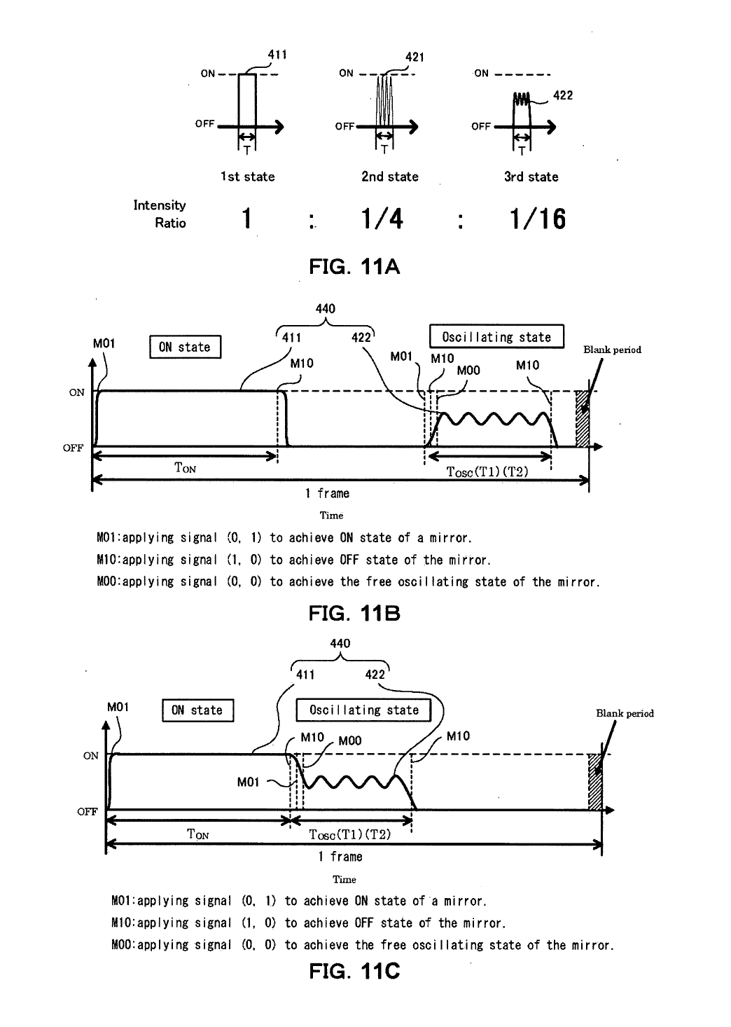

FIG. 11A shows a control diagram applied to an image display system to control the micromirrors to reflect a partial reflection at a 1/16 of brightness. Various computerized analyses and simulations have found that it is possible to stop or reduce the movements of mirrors by adding suitable pulses to the electrodes. FIG. 11A illustrates a case of setting a second state by applying the second mirror control signal 421. In the second state, the light intensity reflected from the oscillating micromirror 212 is ¼ (25%). In a third state when applying a third mirror control signal 422 the micromirror reflect a light intensity of about 1/16 of the fully ON intensity. In the third mirror control state, the control signal 422 controls the micromirror 212 to oscillate with less angular amplitude than that of the second mirror control signal 421. By combining the second control state of this control process with an image display system controllable to display image of 256 gray scales, the display system has an increased number, up to 1024, of gray scales that is equivalent to a 10-bit control. By combining the second and third control states of this control process with an image display system controllable to display image of 256 gray scales, the display system has an increased number, up to 4096, of gray scales that is equivalent to a 12-bit control.

FIG. 11B is a control diagram for illustrating a control method for holding a mirror at the middle position and keeping the oscillation to a minimum when the initial position of the mirror is at an OFF position. A third mirror control signal 422 is applied in this control process. This control process changes the angular range of the oscillation when the mirror is operated in an oscillating state for the purpose of adjusting the light intensity.

According to FIG. 11b, the third mirror control signal 422 is applied to control the mirror according to following procedures:

(1) Applying a signal (0, 1) to move a micromirror from the OFF state to an ON state (i.e., the control operation M01);

(2) Before the mirror reaches at the ON state, applying a signal (1, 0) to reduce the speed of movement toward the ON state (i.e., the control operation M10);

(3) Before the angular velocity of the mirror reaches at zero, applying signal (0, 0) to start oscillating the mirror;

(4) Keeping applying the signal (0, 0) during the oscillating period; and

(5) Applying a signal (1, 0) to stop the oscillation after the mirror reaches at the maximum angle, applying a signal (1, 0) during the period until the mirror moves to the other side and reaches at the minimum angle, then control the mirror to operate in the OFF state by applying the control operation M10.

In this control process, the oscillation control time Tosc is calculated on the basis of a light intensity calculated by using the ratio of a light intensity (i.e., a reflection light intensity L). The ratio of the light intensity is obtained by dividing the light intensity reflected from the mirror in one oscillation of a micromirror 212 by a light intensity reflected by the micromirror 212 kept in an ON state for the time duration of one oscillation.

The control diagram shown in FIG. 11C illustrates an example of controlling a mirror operating from an ON state by applying the first mirror control signal 411 to an oscillating state and then applying the second mirror control signal 421.

The control process of FIG. 11C in applying the second mirror control signal 421 is carried out by performing the following processes:

(1) Applying a signal (1, 0) at the end point of the ON state (i.e., the control operation M10);

(2) Before the mirror reaches at the OFF state, applying a signal (0, 1) to reduce the moving speed of the mirror toward the OFF state (i.e., the control operation M01);

(3) Before the angular velocity of the mirror reaches at zero, applying a signal (0, 0) to start oscillating the mirror (i.e., the control operation M00);

(4) Keeping applying the signal (0, 0) during the oscillating period; and

(5) Applying signal (1, 0) to stop oscillating. After the mirror reaches a maximum oscillation angle, applying a signal (1, 0) until the mirror moves to the other side and reaches at the minimum angle, then control the mirror in the OFF state (i.e., the control operation M10). The oscillation control time Tosc is calculated on the basis of a light intensity obtained by using the ratio of a light intensity (i.e., a reflection light intensity L). The ratio of the light intensity is obtained by dividing the light intensity reflected from the mirror in one oscillation by a light intensity reflected from the micromirror 212 operated in an ON state for the time duration of one oscillation of the micromirror 212.

Further control processes are implemented by making use of an incomplete oscillation. FIGS. 12A through 12C illustrate the results of a simulation analysis when controlling one oscillation by using a standard oscillation cycle of a micromirror 212. FIG. 12A is a simulation in the case of the oscillation cycle being the longest at 15.05 microseconds due to the variation of the thickness of the hinge 213. FIG. 12B shows the oscillation cycle of 14.14 microseconds when the thickness of the hinge 213 is designed with a standard value. FIG. 12C shows an oscillation cycle with a shortest cycle at 13.34 microseconds by changing the thickness of the hinge 213. The waveform starts from the time when the oscillation start and ends at a time a control signal is applied to control the micromirror to the OFF state. The total length of time is 14 microseconds that is slightly shorter than the oscillation period T=14.14 of the standard micromirror 212.

The ratio of a light intensity is obtained by using the ratio of the reflections of the individual micromirrors 212 to a light intensity obtained by controlling it under the ON state only for the period of 14 microseconds. The ratio has a value of 26.57% for a hinge 213 of the micromirror 212 that has a standard thickness. The ratio is 28.24% for one of the longest oscillation cycle, and 25.07% for one indicating the shortest oscillation cycle.

As described above, in controlling a micromirror by using an average value of the oscillation cycles of the micromirrors 212, the state of pulse of the reflection light generated by the micromirror 212 is fluctuated and has a variation in the production of the spatial light modulation elements 200. The variations may cause an error in calculation. Accordingly, the present embodiment is configured to calculate the time duration for controlling the oscillation so as to increase the number of oscillations of a mirror and calculate the ratio of light intensity based on a condition that the probability of the occurrence of incomplete oscillation is small. The calculation thus reduces an influence of the variation of pulse of the reflection light described above and improving the accuracy of the calculated light intensity.

FIGS. 13A and 13B are intensity diagrams for showing the results of a simulation analysis in calculating an oscillation control time To at 98 microseconds so as to generate seven oscillations by using 14 microseconds as a standard oscillation cycle. FIG. 13A shows the results that the oscillation cycle is the longest at 15.04 microseconds with seven oscillations and FIG. 13B shows the results that the oscillation cycle is the shortest at 13.34 microseconds with eight oscillations. The changes of oscillation cycle are adjusted by changing the thickness of the hinge 213.

The ratio of the light intensity generated by the mirror operated with oscillations relative to the light intensity when the mirror is operated in an ON state for a period of To (i.e., 98 microseconds) in the respective cases are 32.74% and 33.02%. The difference of brightness between the maximum and minimum is only 1%. Although the numbers of oscillations are different, the difference of Intensity Ratio between the two examples is apparently smaller, to a practically negligible level in comparison to oscillations shown in FIGS. 12A to 12C when the number of oscillation is small.

This result apparently shows the effects of setting an oscillation control time to so as to increase the number of oscillations as a method for suppressing a fluctuation of the light intensity generated from oscillating the micromirror 212. Based on these analyses, image display systems to control intermediate states of micromirrors using pre-fixed driving time for oscillating the mirrors can be determined. The pre-defined time can be determined by taking into account of the design variations or the average measurement that factoring in the performance and configuration differences of micromirror due to the production processes variations.

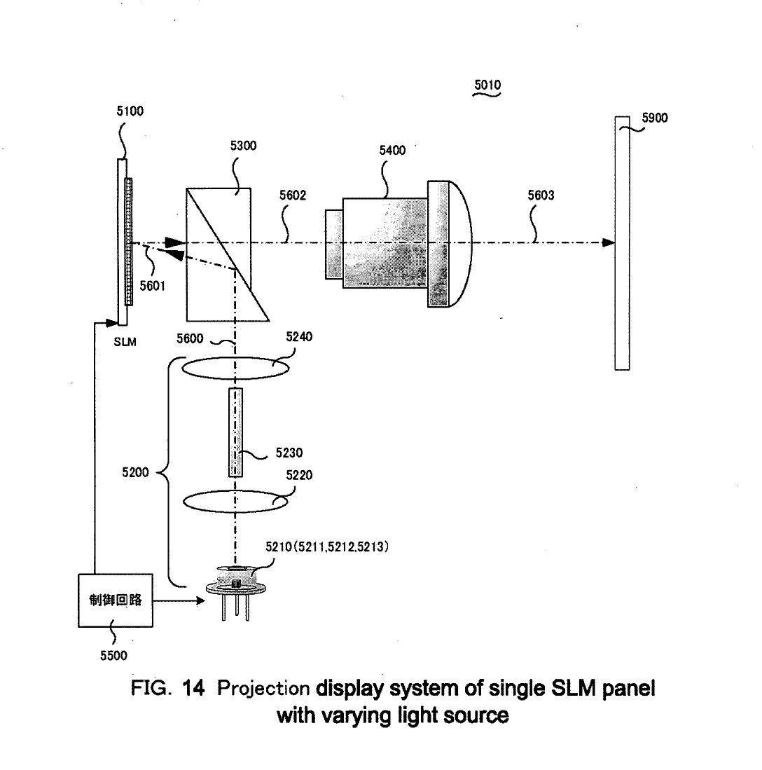

FIG. 14 is a functional block diagram for showing a configuration of a projection apparatus according to a preferred embodiment of the present invention. A projection apparatus 5010 according the present embodiment comprises a single spatial light modulator (SLM) 5100, a control unit 5500, a total internal reflection (TIR) prism 5300, a projection optical system 5400 and a light source optical system 5200 as exemplified in FIG. 14. The projection apparatus 5010 is a so-called single-plate type projection apparatus 5010 comprising a single spatial light modulator 5100. The spatial light modulator 5100 and TIR prism 5300 are placed in the optical axis of the projection optical system 5400, and the light source optical system 5200 is placed in a manner that the optical axis thereof is in different angle from that of the projection optical system 5400. The TIR prism 5300 provides the function of making an illumination light 5600, which is incident from the light source optical system 5200 positioned on the side, incident to the spatial light modulator 5100 at a prescribed inclination angle as an incident light 5601 and also making a reflection light 5602, which is approximately vertically reflected on the spatial light modulator 5100, transmit to the projection optical system 5400.

The projection optical system 5400 projects the reflection light 5602, to transmit through the spatial light modulator 5100 and TIR prism 5300, to project to a screen 5900 or the like as a projection light 5603 for image display. The light source optical system 5200 comprises a variable light source 5210, a condenser lens 5220 for focusing the light source fluxes from the variable light source 5210, a rod type condenser body 5230 and a condenser lens 5240. The variable light source 5210, condenser lens 5220, rod type condenser body 5230 and condenser lens 5240 are placed, in this order, in the optical axis of the illumination light 5600 emitted from the aforementioned variable light source 5210 and incident to the side of the TIR prism 5300.

The projection apparatus 5010 implements a color display on the screen 5900 by using a single spatial light modulator 5100 by applying a sequential color display method. The variable light source 5210, may include a red laser light source 5211, a green laser light source 5212 and a blue laser light source 5213 which allow individual controls of the emission states, performs the operation of dividing one frame of display data into a plurality of sub-fields (i.e., three sub-fields corresponding to red (R), green (G) and blue (B) in this case) and making each of the red laser light source 5211, green laser light source 5212 and blue laser light source 5213 turned on in time series at the time band corresponding to each color as described in detail later. With the configuration as shown for, the projection apparatus 5010, the control unit 5500 similarly configured to the control apparatus 300 described above controls the spatial light modulator 5100 (i.e. the spatial light modulation element 200).

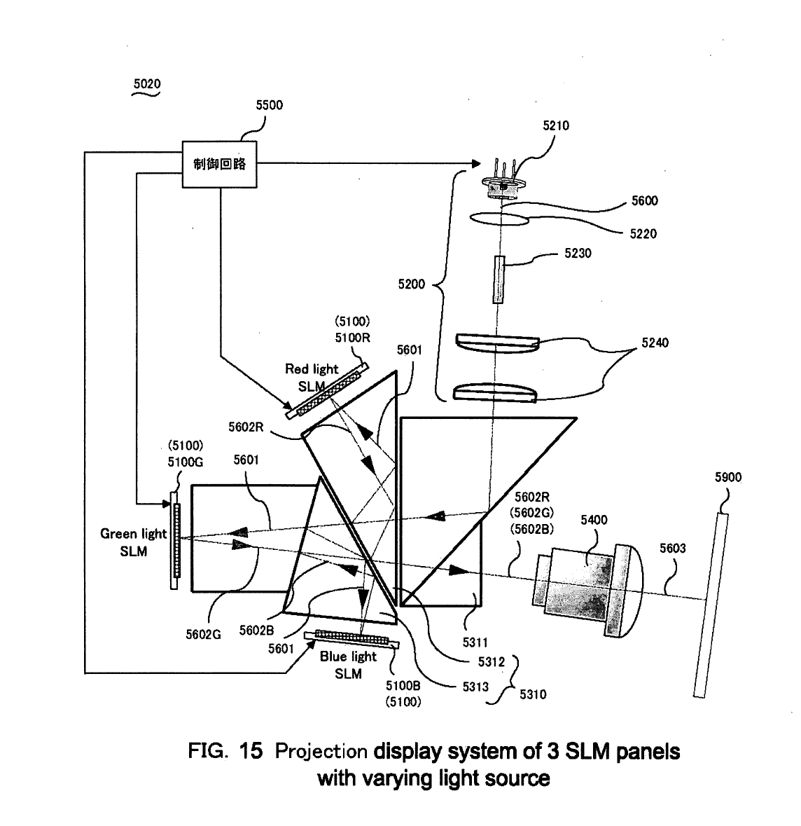

FIG. 15 is a functional block diagram for showing a configuration of a projection apparatus according to another preferred embodiment of the present invention. The projection apparatus 5020 is a so-called multiple-plate projector comprising a plurality of spatial light modulators 5100 (i.e., 5100R, 5100G and 5100B), which is the difference from the above described projection apparatus 5010. The projection apparatus 5020 comprises a plurality of spatial light modulators 5100, and a light separation/synthesis optical system 5310 is provided between the projection optical system 5400 and each of the spatial light modulators 5100. The light separation/synthesis optical system 5310 comprises a TIR prism 5311, color separation prism 5312 and color separation prism 5313. The TIR prism 5311 has the function of leading an illumination light 5600 incidents from the side of the optical axis of the projection optical system 5400 to the spatial light modulator 5100 side. The color separation prism 5312 has the functions of separating red (R) light from an incident light 5601 incident by way of the TIR prism 5311 and making the red light incident to the red light-use spatial light modulators 5100R, and of leading the reflection light 5602R of the red light to the TIR prism 5311.

Similarly to above described image display systems, the color separation prism 5313 has the functions of separating blue (B) and green (G) lights from the incident light 5601 transmitted through the IR prism 5311 and projected to the blue color-use spatial light modulators 5100B and green color-use spatial light modulators 5100G, and of leading the reflection light 5602B of the blue and the reflection light 5602G of the green light to the TIR prism 5311. Therefore, the spatial light modulations of three colors of R, G and B are simultaneously performed at three spatial light modulators 5100, respectively, and the reflection lights 5602R, 5602B and 5602G after the operation of the modulations become the projection light 5603 through the projection optical system 5400 to project on the screen 5900 to carry out color display.

In this exemplary embodiment of the projection apparatus 5020, the control unit 5500 is configured similarly to the control apparatus 300 described above that controls the plurality of spatial light modulators 5100 by using the modulation control signal 440 combining the first mirror control signal 411 and second mirror control signal 421 as described above. It is understood that various modifications are conceivable for a light separation/synthesis optical system in lieu of being limited to the light separation/synthesis optical system 5310.

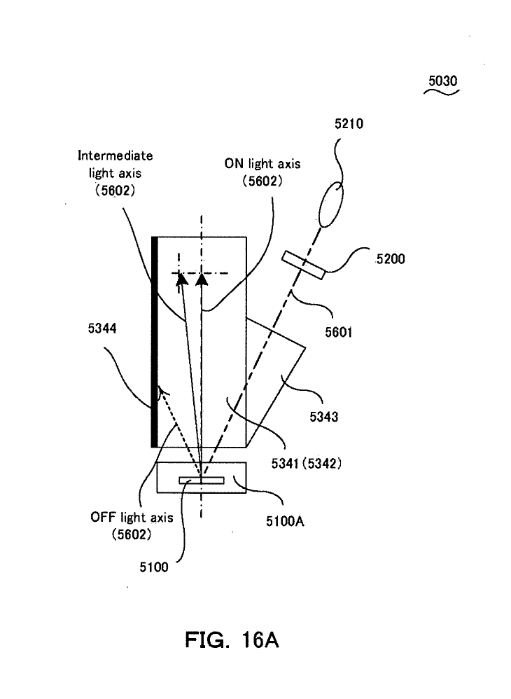

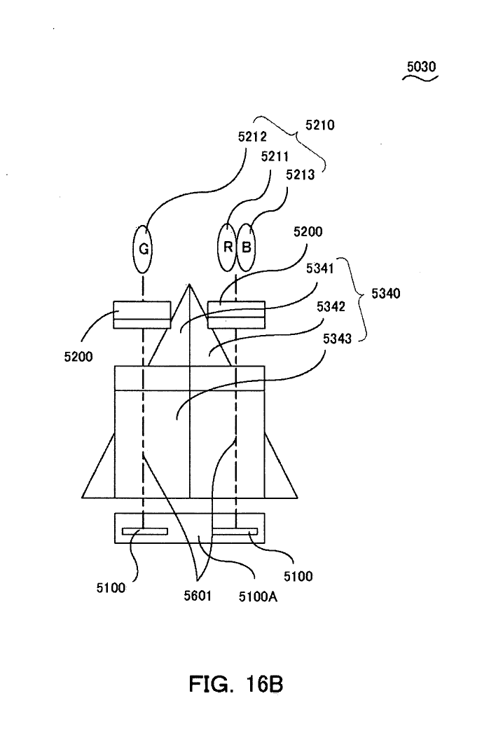

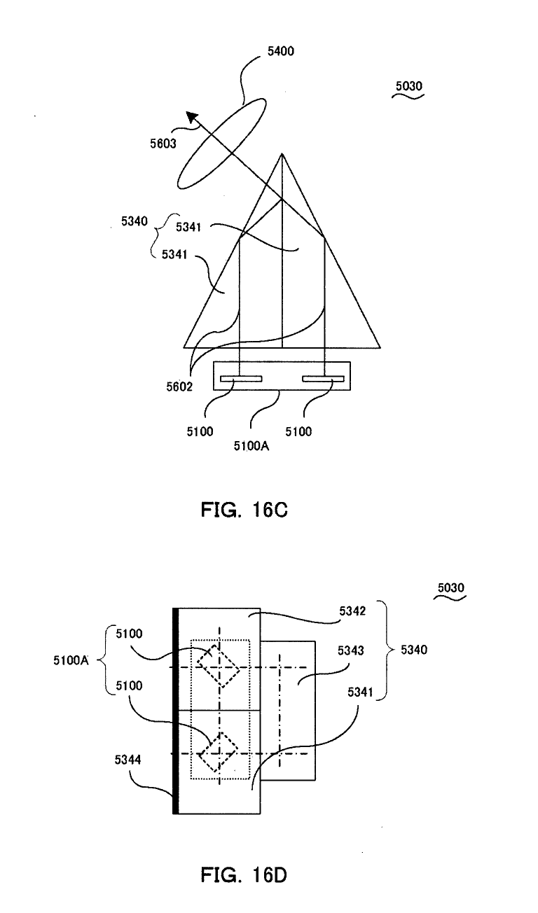

FIGS. 16A, 16B, 16C and 16D are configuration diagrams of the optical system of a projection apparatus using a plurality of spatial light modulators 5100. FIG. 16A is a side view of a synthesis optical system according to the present embodiment; FIG. 16B is the front view; FIG. 16C is the rear view; and FIG. 16D is the upper plain view. The optical system of a projection apparatus 5030 according to the present embodiment comprises a device package 5100A integrally incorporating a plurality of spatial light modulators 5100, a color synthesis optical system 5340, a light source optical system 5200 and a variable light source 5210. The plurality of spatial light modulators 5100 (i.e., spatial light modulation elements 200) incorporated in the device package 5100A are fixed in a manner that the rectangular contour of each of the modulators 5100 is inclined by approximately 45 degrees, in the horizontal plane, in relation to each side of the device package 5100A of similar rectangular contour.

The color synthesis optical system 5340 is placed on the device package 5100A. The color synthesis optical system 5340 comprises prisms 5341 and 5342 of a right-angle triangle pole of a result of joining together so as to make an equilateral triangle column on the longitudinal side and a light guide block 5343 of a right-angle triangle column of a result of joining slope surfaces, with the bottom surface facing up, on the side faces of the prisms 5341 and 5342. A light absorption body 5344 is provided on the prisms 5341 and 5342, on the side surface and on the reverse side of the face where the light guide block 5343 is adhesively attached.

The bottom of the light guide block 5343 is equipped with the light source optical system 5200 of the green laser light source 5212, and the light source optical system 5200 of the red laser light source 5211 and blue laser light source 5213, with each of them having a vertical optical axis. The illumination light 5600 emitted from the green laser light source 5212 is incident to the spatial light modulator 5100, on one side, which is positioned immediately under the prism 5341 as an incident light 5601 through the light guide block 5343 and prism 5341. Also, the illumination lights 5600 respectively emitted from the red laser light source 5211 and blue laser light source 5213 are incident to the spatial light modulator 5100, on the other side, which is positioned immediately under the prism 5342 as the incident light 5601 by way of the light guide block 5343 and prism 5342.

The red and blue incident lights 5601 projected onto the spatial light modulator 5100 is reflected along a vertically upward direction as a reflection light 5602 transmitted into the prism 5342 to further reflect from the external surface that is adhesively attached. According to this order of light transmission through the prism 5342, followed by transmitting the light to the projection optical system 5400 for displaying an image by applying the projection light 5603. Meanwhile, the green incident light 5601 is projected to the spatial light modulator 5100 and reflected vertically upward to project as a reflection light 5602 through the prism 5341 and further reflected from the external surface of the prism 5341, along the same light path as the red and blue reflection lights 5602 and incident to the projection optical system 5400. The light projected through the projection optical system 5400 is processed to become the projection light 5603 when the state of the mirror 212 is operated in the ON state.

As described above, the mirror device according to the present embodiment is configured to include at least two spatial light modulators 5100 in a single device package 5100A. One module is illuminated only with the incident light 5601 from the green laser light source 5212. The other one module of the spatial light modulator 5100 is illuminated with the incident light from the red laser light source 5211 and blue laser light source 5213. Those two lights illuminates said module sequentially or simultaneously. Individual modulation lights respectively modulated by two these two spatial light modulators 5100 are projected to the color synthesis optical system 5340 as described above. The light projected from the color synthesis optical system is further magnified by the projection optical system 5400 and projected onto the screen 5900 or the like as the projection light 5603 for image display. Also the projection apparatus 5030 according to the present embodiment comprises a control apparatus 300 which controls the spatial light modulator 5100 by using the modulation control signal 440 including the first mirror control signal 411 and second mirror control signal 421 according to various embodiments and combinations of various control methods as described above.

Although the present invention has been described in terms of the present preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as falling within the true spirit and scope of the present invention.

What is claimed is:

1. A display system, comprising:
a) a display device having a plurality of mirrors controllable to operate at an oscillating state; and
b) a processor processing an input video signal and controlling said display device, wherein
said processor generates a control signal for controlling each of said plurality of mirrors based on either a reflection light intensity L, or an oscillation period T for oscillating said mirrors.

2. The display system of claim 1, wherein:
said processor further calculating said light intensity L and/or said oscillation period T based on a set of design parameters.

3. The display system of claim 1, wherein:
said processor further calculating said light intensity L and/or said oscillation period T based on a set of measurements of mirror design parameters.

4. The display system of claim 2, wherein:
said processor further calculating said light intensity L and/or said oscillation period T based on a set of design parameters or measurements of mirror design parameters for a selected mirror disposed substantially in a center area of said plurality of mirrors.

5. The display system of claim 2, wherein:
said processor further calculating said light intensity L and/or said oscillation period T based on a set of design parameters or measurements of mirror design parameters of a selected mirror disposed in a periphery area of said plurality of mirrors.

6. A display system, comprising:
a) a display device which has a plurality of mirrors, and which has an ON state, an OFF state, and an oscillating state, of the mirror; and
b) a processor processing an input video signal and controlling said display device, wherein
said processor generates a control signal for controlling individual mirrors constituting an image based on a ratio of light intensity obtained by oscillating a predetermined mirror in duration of an oscillation period T to light intensity obtained by putting the mirror in ON state for duration of said oscillation period T.

7. The display system of claim 6, wherein:
said oscillation period T of said predetermined mirror and/or said ratio of light intensity obtained by oscillating said predetermined mirror for said oscillation period T to light intensity obtained by putting the mirror in ON state for duration of said oscillation period T are/is values, or a value, calculated theoretically from a design value of the mirror.

8. The display system of claim 6, wherein
said oscillation period T of said predetermined mirror and/or said ratio of light intensity obtained by oscillating said predetermined mirror for said oscillation period T to light intensity obtained by putting the mirror in ON state for duration of said oscillation period T are/is values, or a value, calculated from a measurement value of the mirror.

9. The display system of claim 6, wherein:
said oscillation period T and/or said ratio of the light intensity are calculated theoretically from a design value of said mirror or calculated from a measured value of a mirror formed in a center area of said plurality of mirrors.

10. The display system of claim 1, wherein:
said oscillation is a free oscillation of the mirror.

11. The display system of claim 6, wherein:
said oscillation is a free oscillation of the mirror.

12. The display system of claim 1, wherein:
said oscillation is performed approximately between the ON state and OFF state of the mirror.

13. The display system of claim 6, wherein:
said oscillation is performed approximately between the ON state and OFF state of the mirror.

14. The display system of claim 1, wherein:
said oscillation is performed between the ON state and OFF state of the mirror.

15. The display system of claim 6, wherein:
said oscillation is performed between the ON state and OFF state of the mirror.

16. The display system of claim 1, wherein:
said oscillation is performed between the ON state of said mirror and the neutral position thereof, or between the OFF state of the mirror and the neutral position thereof.

17. The display system of claim 6, wherein
said oscillation is performed between the ON state of the mirror and the neutral position thereof, or between the OFF state of the mirror and the neutral position thereof.

18. A control method for generating a gray scale by using a modulation of a mirror by putting it in an oscillating state in a display device having a plurality of mirrors and an oscillating state, comprising the steps of:
a) inputting a video signal to a processor;
b) calculating a time duration within a frame for performing a modulation by putting individual mirrors constituting an image in the oscillating state in accordance with the video signal on the basis of a value of a light intensity L, and/or that of an oscillation period T, of a predetermined mirror; and
c) generating a control signal for controlling each of the mirrors constituting an image based on the calculated time duration for performing the modulation.

19. A control method for generating a gray scale by using a modulation of a mirror by putting it in an oscillating state in a display device having a plurality of mirrors and an oscillating state, comprising the steps of:
a) inputting a video signal to a processor;
b) calculating a time duration within a frame for performing a modulation by putting each of the mirrors constituting an image in the oscillating state in accordance with the video signal on the basis of the ratio of a light intensity obtained by oscillating a predetermined mirror in an oscillation period T to a light intensity obtained by putting the mirror in an ON state for a duration of the oscillation period T; and
c) generating a control signal for controlling each of the mirrors constituting an image based on the calculated time duration for performing the modulation.

20. The method of claim 18, wherein:
said time period is calculated as a series of duration.

21. The method of claim 19, wherein:
said time period is calculated as a series of duration.

22. The method of claim 18, wherein:
said time duration for performing a modulation is calculated as divided into a predetermined time durations.

23. The method of claim 19, wherein:
said time duration for performing a modulation is calculated so as to be divided into a predetermined time durations.

24. The method of claim 18, wherein:
said time period is calculated such that a duration is at least two cycles of the oscillation period T.

25. The method of claim 19, wherein:
said time period is calculated such that a duration is at least two cycles of the oscillation period T.

26. The method of claim 19, wherein:
said ratio of an intensity obtained by the oscillating state during the oscillation period T to an intensity obtained by the ON state during the oscillation period T is approximately 6.3%.

27. The method of claim 19, wherein:
the ratio of an intensity obtained by the oscillating state during the oscillation period T to an intensity obtained by the ON state during the oscillation period T is approximately 12.5%.

28. The method of claim 19, wherein:
the ratio of an intensity obtained by the oscillating state during the oscillation period T to an intensity obtained by the ON state during the oscillation period T is approximately 20%.

29. The method of claim 19, wherein:
the ratio of an intensity obtained by the oscillating state during the oscillation period T to an intensity obtained by the ON state during the oscillation period T is approximately 25%.

30. The method of claim 19, wherein:
the ratio of an intensity obtained by the oscillating state during the oscillation period T to an intensity obtained by the ON state during the oscillation period T is approximately 33%.

31. The method of claim 19, wherein:
the ratio of an intensity obtained by the oscillating state during the oscillation period T to an intensity obtained by the ON state during the oscillation period T is approximately 50%.
